(19) United States
(12) Patent Application Publication
(10) Pub. No.: US 2004/0238506 A1
(43) Pub. Date: Dec. 2, 2004

(54) Method of decorating a support comprising a transparent outer layer

(76) Inventor: Robert Petit, Savigny-Sur-Orge (FR)

Correspondence Address: YOUNG & THOMPSON, 745 SOUTH 23RD STREET, 2ND FLOOR, ARLINGTON, VA, 22202, US

(21) Appl. No.: 10/847,471

(22) Filed: May 18, 2004

(30) Foreign Application Priority Data
May 26, 2003 (FR) 03 06317

(51) Int. Cl. B23K 26/00

(52) U.S. Cl. 219/121.69

(57) ABSTRACT

In this method:

a) the said support (1) is chosen so as to include a transparent outer layer CE (2), and a typically opaque inner layer CI (3), so as to form a total or partial barrier to transmission of light,

b) radiation is applied to the outside of the said support (1), the said support typically being transparent for the said radiation, the said radiation forming an energy beam (50) capable of locally modifying a part CIA (30) of the said inner layer CI (3), so as to obtain a support (1′) with a visual contrast between the said altered part CIA (30) of the said inner layer CI (3) and the unaltered part or the original part CIO (31) of the said inner layer CI (3), the said inner layer CI (3) thus forming an image or a decoration pattern (7), and typically a logo, visible by an external observer.

### FIELD OF THE INVENTION

The invention relates to methods of marking or decorating supports, particularly in the field of packaging, and more particularly in the field of packaging of cosmetics, for example in the domain of compact.

### STATE OF THE ART

A wide variety of different means are used for the decoration of cosmetic packagings.

In general, these packagings are formed by moulding of a thermoplastic material, such that the colour or final appearance of the packaging is obtained starting from a thermoplastic material itself with in-body colouring.

It is also known how to mark a support with gold plating, typically by hot transfer of a layer of gold plating provided from an auxiliary support.

In some cases, a support can also be metallised so as to give a metallic appearance and metallic reflections to a support.

It is also known how to spray a marking means, typically ink, on a support.

### PROBLEMS THAT ARISE

For cosmetics, decoration or the appearance of the packaging forms an essential means for differentiating marketed products, when the packaging is open and when it is closed, and it also undoubtedly forms an essential means of attracting the potential buyer.

Therefore, there is a permanent search for decoration and marking methods to obtain new effects.

### DESCRIPTION OF THE INVENTION

In the method according to the invention for decorating a support, the said support forms all or part of a packaging or distribution means of a product, typically a cosmetic, and:

a) the said support is chosen so as to include a transparent outer layer CE, and a typically opaque inner layer CI, so as to form a total or partial barrier to transmission of light, and such that the said inner layer CI contributes to the visual impression left by the said support to an external observer,

b) radiation is applied to the outside of the said support, the said support typically being transparent for the said radiation, the said radiation forming an energy beam capable of locally modifying a part CIA of the said inner layer CI, so as to obtain a support with an inner layer CI′ with a visual contrast between the said altered part CIA of the said inner layer CI and the unaltered part or the original part CIO of the said inner layer CI, the said inner layer CI′ then comprising all CIA and CIO parts, and thus forming an image or a decoration pattern, and typically a logo, visible by the said external observer.

Typically, the said layer CE transparent to visible light is colourless. However, it may be coloured without necessarily masking the said layer CI to the passage of light rays.

The method according to the invention is particularly adapted to typically monochrome marking or to the production of typically monochrome images to the extent that the method according to the invention does not add any colour but alters or locally removes material so as to create a contrast, which is why this method can thus be qualified as a “subtractive” or “destructive” type method.

The energy beam can also be scanned to write messages or words, like remote etching.

The method according to the invention is applicable to all supports provided with two layers CE and CI, initially with a structure symbolically denoted as CE/CI, and after treatment according to the invention, a structure symbolically denoted as CE/CIA+CIO.

Since the CE layer is transparent for the said energy beam, this layer remains completely insensitive to passage of the said beam, or at least it is not significantly altered by passage of the said beam.

The effect obtained with the image or the pattern obtained according to the method may be similar to the effect that is wanted when a glass or Plexiglas plate protects a decor, the plate with a certain thickness playing a role in the overall perception, particularly for small or non-plane objects.

The method according to the invention is particularly applicable in all cases in which the inner layer CI is not directly accessible for various reasons, and the only way to alter it is through the outer layer CE.

### DESCRIPTION OF THE FIGURES

All figures relate to the invention.

FIG. 1a is a partial sectional view of a support (1) in a plane perpendicular to the said support. The said support includes two superposed layers, an outer layer CE transparent to natural light (2) and an inner layer CI (3).

FIGS. 1b and 1c are views similar to the view in FIG. 1a, diagrammatically showing an energy beam generation device (5) and its beam (50), the said beam (50) being a parallel beam (500) in FIG. 1b and a beam (501) focussed on the said inner layer CI (3) in FIG. 1c.

FIG. 1d is a view similar to the view in FIG. 1a of the said support (1′) marked or decorated using the method according to the invention.

FIGS. 2a, 2c, 2e, 3a and 3c are views similar to the view in FIG. 1a but relate to a mirror (6).

The corresponding FIGS. 2b, 2d, 2f, 3b and 3d are top views of the said mirror (6).

FIGS. 2a and 2b relate to the initial mirror (6) used as a support (1) according to the invention, that only comprises the CE and CI layers.

FIGS. 2c and 2d relate to one variant of the method according to the invention in which the support (1, 6) of FIGS. 2a and 2b is used, the pattern obtained being shown in FIG. 2d.

FIGS. 2e and 2d relate to a variant in which, after the pattern in FIG. 2d has been obtained, a contrast layer CC′ (4′) is applied on the inside which has the effect of modifying the appearance of the pattern (7).

FIGS. 3a to 3d relate to another variant of the method according to the invention in which the support (1, 6) initially comprises a contrast layer CC (4) as illustrated in FIG. 3a, similar to that in FIG. 2a, the FIG. 3b being identical to FIG. 2b.

FIGS. 3c and 3d correspond to FIGS. 2c and 2d or 2e and 2f.

As can be seen in FIG. 3c, the laser beam locally alters the inner layer CI without substantially affecting the contrast layer CC (4).

FIGS. 3e to 3g are axial sections for the case in which the said support (1) forms a receptacle body (8).

FIG. 3e shows a moulded part (80) forming a blank for the receptacle body.

FIG. 3f illustrates a variant of forming the layers CI (3) and CC (4) by spraying a fluid dispersion (90) for each layer CI and CC, using an atomisation device (9) so as to obtain the said support (1).

FIG. 3g shows the marked receptacle body (8′).

For reasons of clarity, only the inner layer CI or CI′ (central layer between the CE and CC layers) is cross-hatched.

Similarly, for reasons of clarity, the said altered inner layer CIA or CIA′ has been represented diagrammatically and symbolically by a single blank space in all sections in the figures.

### DETAILED DESCRIPTION OF THE INVENTION

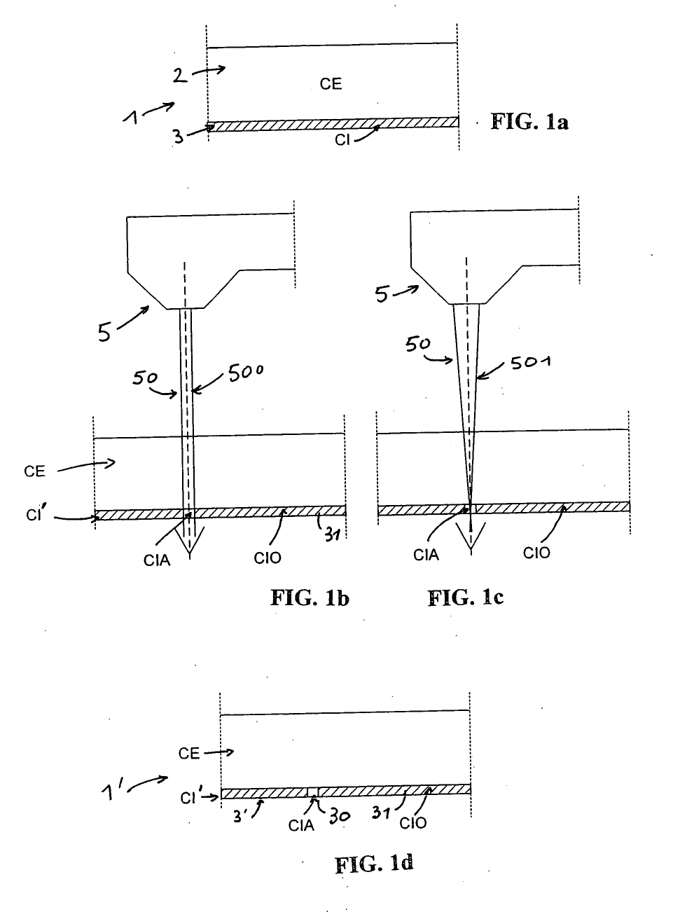

The said energy beam (50) according to the invention may be a laser beam, as illustrated in FIGS. 1b and 1c.

The said laser beam (50) may be formed by a YAG type laser (5) with a power varying typically from 10 W to 200 W.

The said laser beam (50) can scan all or part of the said support (1), typically by displacement perpendicular to the said support (1). The objective is to scan within the area in which the said pattern (7) is to be formed.

As illustrated in FIG. 1b, the said beam (50) may be a parallel beam (500).

However, as illustrated in FIG. 1c, the said beam (50) may be a focussed non-parallel beam (501) with a focal point typically located at the said inner layer CI (3).

According to one variant of the invention, the said inner layer CI (3) may be a metallic layer.

Thus, the said inner layer CI (3) may be formed by the silvering (60) of a mirror.

The said inner layer CI (3) may be a metallic or mineral layer typically formed by vacuum deposition with a thickness typically varying from 10 nm to 500 nm.

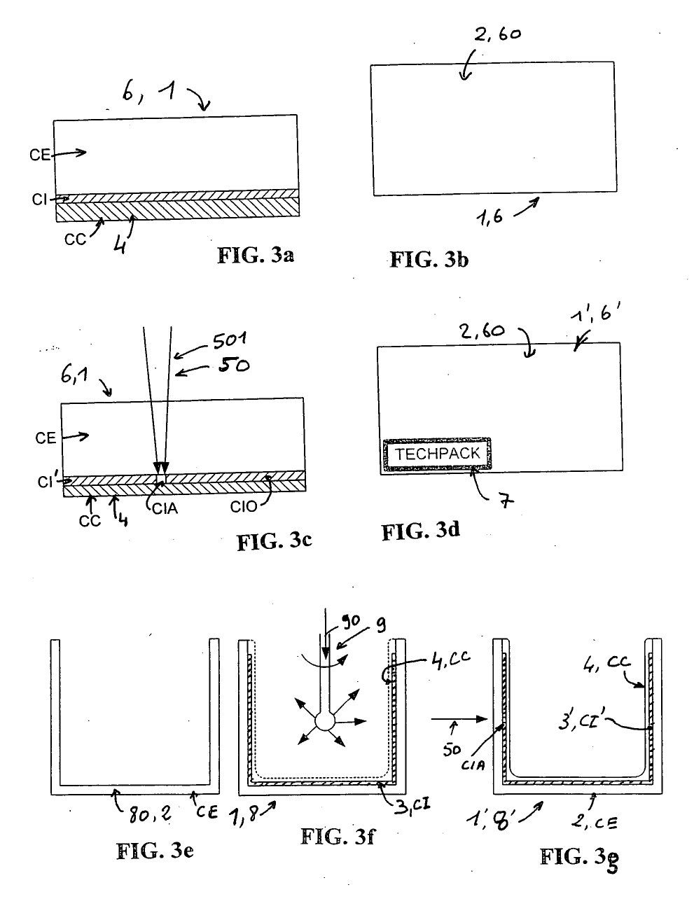

As illustrated in FIG. 3f, the said inner layer CI (3) may also be a thin layer typically formed by application of a fluid dispersion (90), typically a paint comprising an opaque pigmenting filler, the thickness of the said inner layer CI (3) typically varying from 10 μm to 500 μm.

According to the invention, the said beam (50) may locally destroy the said inner layer CI (3) such that the said altered inner layer CIA (30) locally forms a recess or a window CIA′ (30′) capable of allowing light to pass through.

According to one embodiment of the invention illustrated in FIGS. 3a to 3d, the said support (1) may include a so-called contrast layer CC (4), typically opaque, the said inner layer CI (3) being included between the said outer layer CE (2) and the said contrast layer CC (4), such that the said external observer can see the said contrast layer, typically coloured, through the said window CIA′ (30′).

The thickness of the said contrast layer CC (4) may be at least twice as thick as the said inner layer CI (3).

The said contrast layer CC (4) may be a thin layer typically formed from a fluid dispersion (90).

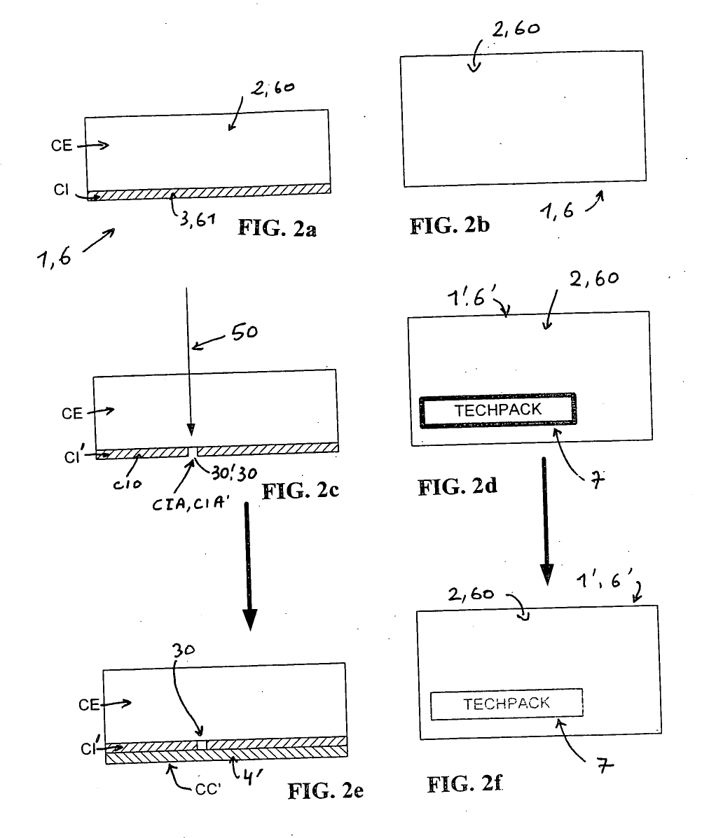

According to another variant of the invention illustrated in FIGS. 2c to 2f, a contrast layer CC′ (4′) may be formed on the said inner layer CI (3′) subsequent to the action of the said energy beam.

As illustrated in FIGS. 2a to 3d, and as already mentioned, the said support (1) can form a mirror (6), the said outer layer CE (2) forming a mineral or organic glass layer (60), the said inner layer CI (3) forming the silvering (61) of the said mirror (6), the said mirror (6) typically being associated with a compact containing cosmetic, typically in the form of a makeup powder.

The said outer layer CE (60) may be made of an organic glass between 1 mm and 2 mm thick, and typically between 1.2 and 1.4 mm thick, the said silvering (61) comprising a pure metallic silver layer with a thickness varying from 1 μm to 5 μm, and typically varying from 2 μm to 4 μm, the said silvering (61) of the mirror (6) possibly being coated with a protective varnish.

As illustrated in FIGS. 3e to 3g, the said support (1) may form all or part of an external wall of a receptacle or a body of a means of conditioning or distribution of the said cosmetic (8).

The said transparent outer layer CE (2) may form a typically moulded part (80) made of PMMA, SAN, ABS, PS, PCTA or PCTG.

According to the invention, the wavelength of the said beam (50) of the said laser may vary from 0.4 to 1.2 μm, and typically within the visible range from 0.4 to 0.8 μm.

The cross-section S of the said beam (50) of the said laser at the said inner layer CI and in a plane parallel to the said inner layer CI typically varies between 0.1 mm² and 1 mm², such that scanning of the said beam provides a means of making the said image or the said decoration pattern with the required fineness.

Another purpose of the invention is formed by a support (1′) decorated by the method according to the invention, in which the said support (1) forms a mirror (6) or a packaging for a cosmetic, typically a receptacle (8) or a receptacle element, with a structure symbolically denoted CE/CIO+CIA or CE/CIO+CIA/CC.

It may be formed by a support (1′) with a structure symbolically denoted CE/CIO+CIA in which the altered part CIA is the said altered part CIA′ enabling the passage of light, such that a light source is capable of illuminating the layer CIO+CIA′ from the back, and thus illuminating the said image or the said decoration pattern or the said logo (7).

### EXAMPLE EMBODIMENTS

The figures are example embodiments.

The tested mirrors had a layer CE made of 1.3 mm thick organic glass and a silvering layer CI made of 3 μm thick silver, the silvering layer being coated with a layer of protective varnish.

Bodies were moulded from methyl polymethacrylate PMMA. A white pigmented dispersion based on titanium oxide was sprayed to form the said inner layer CI (3) by atomisation as illustrated in FIG. 3f.

The next step in the variant illustrated in FIG. 4f was to apply a contrast layer CC (4).

All tests were carried out with a YAG laser emitting a power of 100 W in the visible, the scanning of the beam being computer controlled so as to automatically reproduce a required pattern, previously input into the computer memory.

The result is thus a wide variety of visual effects that in particular enable easy marking of mirrors accompanying any type of package.

### ADVANTAGES OF THE INVENTION

The invention has major advantages, particularly for the packaging of cosmetics.

The method can thus provide visual effects completely different from effects known in the past, and secondly can be used to personalize any product to the extent that each decoration of marking operation is done by scanning using an energy beam, typically computer controlled, such that it is possible for example to number a limited series of articles, or even to create the logo of each customer on an otherwise generic product, which in practice is very attractive.

LIST OF MARKS

| | |
|---|---|
| Support | 1 |
| Marked or decorated support | 1′ |
| Outer layer CE | 2 |
| Inner layer CI | 3 |
| Marked or decorated inner layer CI′ | 3′ |
| Altered inner layer CIA or CIA′ | 30, 30′ |
| Original inner layer CIO | 31 |
| Contrast layer CC or CC′ | 4, 4′ |
| Device generating the energy beam | 5 |
| Energy beam | 50 |
| Parallel beam | 500 |
| Focussed beam | 501 |
| Mirror | 6 |
| Marked or decorated mirror | 6′ |
| Mineral or organic glass layer | 60 |
| Silvering | 61 |
| Pattern or décor or logo | 7 |
| Marked or decorated | 8 |
| receptacle or receptacle body | |
| receptacle body | 8′ |
| Receptacle blank | 80 |
| Device or inner coating head | 9 |
| Fluid dispersion | 90 |

1. Method for decorating a support (1), the said support forming all or part of a packaging or distribution means of a product, typically a cosmetic, in which the said support (1) is chosen so as to include a transparent outer layer CE (2), and a typically opaque inner layer CI (3), so as to form a total or partial barrier to transmission of light, and such that the said inner layer CI (3) contributes to the visual impression left by the said support to an external observer, and in which radiation is applied to the outside of the said support (1), the said support typically being transparent for the said radiation, the said radiation forming an energy beam (50) capable of locally modifying a part CIA (30) of the said inner layer CI (3), so as to obtain a support (1′) with an inner layer CI′ (3′) with a visual contrast between the said altered part CIA (30) of the said inner layer CI (3) and the unaltered part or the original part CIO (31) of the said inner layer CI (3), the said inner layer CI′ (3′) then comprising all CIA (30) and CIO (31) parts, and thus forming an image or a decoration pattern (7), and typically a logo, visible by the said external observer.

2. Method according to claim 1, in which the said energy beam (50) is a laser beam.

3. Method according to claim 2, in which the said laser beam (50) is formed by a YAG type laser (5) with a power varying typically from 10 W to 200 W.

4. Method according to claim 1, in which the said laser beam (50) scans all or part of the said support (1), typically by displacement perpendicular to the said support (1).

5. Method according to claim 1, in which the said beam (50) is a parallel beam (500).

6. Method according to claim 1, in which the said beam (50) is a focussed non-parallel beam (501) with a focal point typically located at the said inner layer CI (3).

7. Method according to claim 1, in which the said inner layer CI (3) is a metallic layer.

8. Method according to claim 1, in which the said inner layer CI (3) is formed by the silvering (60) of a mirror.

9. Method according to claim 1, in which the said inner layer CI (3) is a metallic or mineral layer typically formed by vacuum deposition with a thickness typically varying from 10 nm to 5000 nm.

10. Method according to claim 1, in which the said inner layer CI (3) is a thin layer typically formed by application of a fluid dispersion (90), typically a paint comprising an opaque pigmenting filler, the thickness of the said inner layer CI (3) typically varying from 10 μm to 500 μm.

11. Method according to claim 1, in which the said beam (50) locally destroys the said inner layer CI (3) such that the said altered inner layer CIA (30) locally forms a recess or a window CIA′ (30′) capable of allowing light to pass through.

12. Method according to claim 11, in which the said support (1) includes a so-called contrast layer CC (4), typically opaque, the said inner layer CI (3) being included between the said outer layer CE (2) and the said contrast layer CC (4), such that the said external observer can see the said contrast layer, typically coloured, through the said window CIA′ (30′).

13. Method according to claim 12, in which the thickness of the said contrast layer CC (4) is at least twice as thick as the said inner layer CI (3).

14. Method according to claim 12, in which the said contrast layer CC (4) is a thin layer typically formed from a fluid dispersion (90).

15. Method according to claim 1, in which a contrast layer CC′ (4′) is formed on the said inner layer CI (3′) subsequent to the action of the said energy beam.

16. Method according to claim 1, in which the said support (1) forms a mirror (6), the said outer layer CE (2) forming a mineral or organic glass layer (60), the said inner layer CI (3) forming the silvering (61) of the said mirror (6), the said mirror (6) typically being associated with a compact containing cosmetic, typically in the form of a makeup powder.

17. Method according to claim 16, in which the said outer layer CE (60) is made of an organic glass between 1 mm and 2 mm thick, and typically between 1.2 and 1.4 mm thick, the said silvering (61) comprising a pure metallic silver layer with a thickness varying from 1 μm to 5 μm, and typically varying from 2 μm to 4 μm, the said silvering (61) of the mirror (6) possibly being coated with a protective varnish.

18. Method according to claim 1, in which the said support (1) forms all or part of an external wall of a receptacle or a body of a means of conditioning or distribution of the said cosmetic (8).

19. Method according to claim 18, in which the said transparent outer layer CE (2) forms a typically moulded part (80) made of PMMA, SAN, ABS, PS, PCTA or PCTG.

20. Method according to claim 2, in which the wavelength of the beam (50) of the said laser varies from 0.4 to 1.2 μm.

21. Method according to claim 2, in which the cross-section S of the said beam (50) of the said laser at the said inner layer CI and in a plane parallel to the said inner layer CI typically varies between 0.1 mm² and 1 mm², such that scanning of the said beam provides a means of making the said image or the said decoration pattern with the required fineness.

22. Support (1′) decorated by the method according to claim 1, in which the said support (1) forms a mirror (6) or a packaging for a cosmetic, typically a receptacle (8) or a receptacle element, with a structure symbolically denoted CE/CIO+CIA or CE/CIO+CIA/CC.

23. Support (1′) according to claim 22 with a structure symbolically denoted CE/CIO+CIA in which the altered part CIA is the said altered part CIA′ enabling the passage of light, such that a light source is capable of illuminating the layer CIO+CIA′ from the back, and thus illuminating the said image or the said decoration pattern or the said logo (7).
